(19) United States
(12) Patent Application Publication
(10) Pub. No.: US 2002/0101985 A1
(43) Pub. Date: Aug. 1, 2002

(54) Single-cycle hardware implementation of crypto-function for high throughput crypto-processing

(75) Inventors: Jean Louis Calvignac, Cary, NC (US); Mohammad Peyravian, Morrisville, NC (US); Fabrice Jean Verplanken, La Gaude (FR)

Correspondence Address: Joscelyn G. Cockburn, IBM Corporation 2Y7/B656, P.O. Box 12195, Research Triangle Park, NC, 27709, US

(73) Assignee: International Business Machines Corporation, Armonk, NY (US)

(21) Appl. No.: 09/771,472

(22) Filed: Jan. 26, 2001

(51) Int. Cl. H04K 1/04

(52) U.S. Cl. 380/37

(57) ABSTRACT

A hardware implementation of a crypto-function is realized using combinational logic performing computation iterations of the crypto-function on data in a single hardware cycle. Only combinational logic is used to implement the entire cryptographic algorithm, and registers are used only to store input or output from the combinational logic, leading to a very high speed implementation of the crypto-function.

### BACKGROUND OF THE INVENTION

1. Field of the Invention

The present invention generally relates to cryptography and authentication functions in computing and communication equipment and, more particularly, to a hardware implementation of encryption algorithms which allows performing crypto-functions at a very high throughput.

2. Background Description

Cyrpto-functions have long been used in the fields of computers and telecommunications to provide secure data storage, access and transmission and authentication of sources. Both public and private sectors rely on cryptography provide a safeguard against exposure of data and invasions of privacy. In fact, cryptography is the only known practical method for protecting information transmitted through communications networks, and in some cases it may be the most economical way to protect stored data. Cryptographic functions are also used for message authentication, digital signatures and personal identification. In many applications, the crypto-functions are implemented in hardware, providing an almost transparent operation to the user while providing the necessary or desired security.

Hardware implementations have been made of various crypto-functions, typically in Application Specific Integrated Circuits (ASICs). These have been effective in providing fast encryption/decryption and authentication functions. However, the processing of the crypto-functions typically requires many clock or hardware cycles, which has the effect of delaying message transmission or data access. It is desirable to provide even faster encryption/decryption and authentication functions for the next generation of telecommunications and data processing equipment.

### SUMMARY OF THE INVENTION

It is therefore an object of the present invention to provide hardware logic capable of performing crypto-functions at very high throughput, i.e., in the giga-bit per second (Gbps) range.

According to the invention, the crypto-functions implemented in hardware are based on combinational logic design; that is, logic functions whose outputs depend solely on their inputs. These are logic circuits without memory. In contrast to prior hardware implementations of crypto-functions, there are no registers to store intermediate results, or iterations, of the enciphering or deciphering computations. The important feature of the invention is the implementation of the crypto-function in combinatorial logic without intermediate registers that require loading and settling time before the contents of the registers can be read. As a result, the computation is performed in just one hardware cycle, albeit a cycle that may take several clock cycles. The actual computation time is typically one third that of conventional hardware implementations.

In one implementation of the invention, the Data Encryption Standard (DES) algorithm is implemented in combinational logic which performs the encryption or decryption in one hardware cycle. The DES algorithm, as set forth in Federal Information Processing Standards Publication FIPS PUB 463, as reaffirmed Oct. 25, 1999, from the National Institute of Standards and Technology of the U.S. Department of Commerce, is designed to encipher and decipher blocks of data consisting of 64 bits under control of a 64-bit key. A block to be enciphered is subjected to an initial permutation and then to a complex key-dependent computation and finally a permutation which is the inverse of the initial permutation. Deciphering is accomplished by using the same key as for enciphering, but with a schedule of addressing the key bits altered so that the deciphering process is the inverse of the enciphering process. The computation which uses the permuted input block as its input to produce the pre-output block consists, but for a final interchange of blocks, of sixteen iterations of a calculation which operates on two blocks, one of 32 bits and one of 48 bits, and produces a block of 32 bits. In prior hardware implementations, registers are required to store the intermediate results of these sixteen iterations requiring sixteen clock cycles to accomplish the computations, but the combinatorial logic used to implement the algorithm according to the teachings of the present invention perform the computations in one hardware cycle that is approximately ten clock cycles.

The practice of the invention is not limited to an implementation of the DES algorithm. Other crypto-functions, including encryption/decryption and authentication functions, may also be implemented according to the teachings of the invention. For example, another block cipher algorithm that can be implemented using the teachings of the invention is the block cipher called CHAIN as described in “A Structured Symmetric-Key Block Cipher” by Mohammad Peyravian and Don Coppersmith, Computers and Security, Vol. 18, No. 2, pp. 134-147, March 1999. CHAIN uses an invertible key-dependent round function which is iterated a number of times. The round function consists of three stages: mixing, permutation, and key-dependent substitution. The round function uses only three basic operations: exclusive OR (XOR), rotation and substitution. Like DES, the CHAIN round function can be implemented in hardware using only combinational logic without having to store intermediate results in registers. As a result, the iterated round function can be computed in just one clock cycle, leading to a very high throughput implementation. Based on the DES and CHAIN examples, those skilled in the art will find ready application of the teachings of the invention to other cryptographic algorithms.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a logic diagram of a hardware implementation of the DES encryption algorithm; and

FIG. 2 is a logic diagram of a hardware implementation of the DES decryption algorithm.

### DETAILED DESCRIPTION OF A PREFERRED EMBODIMENT OF THE INVENTION

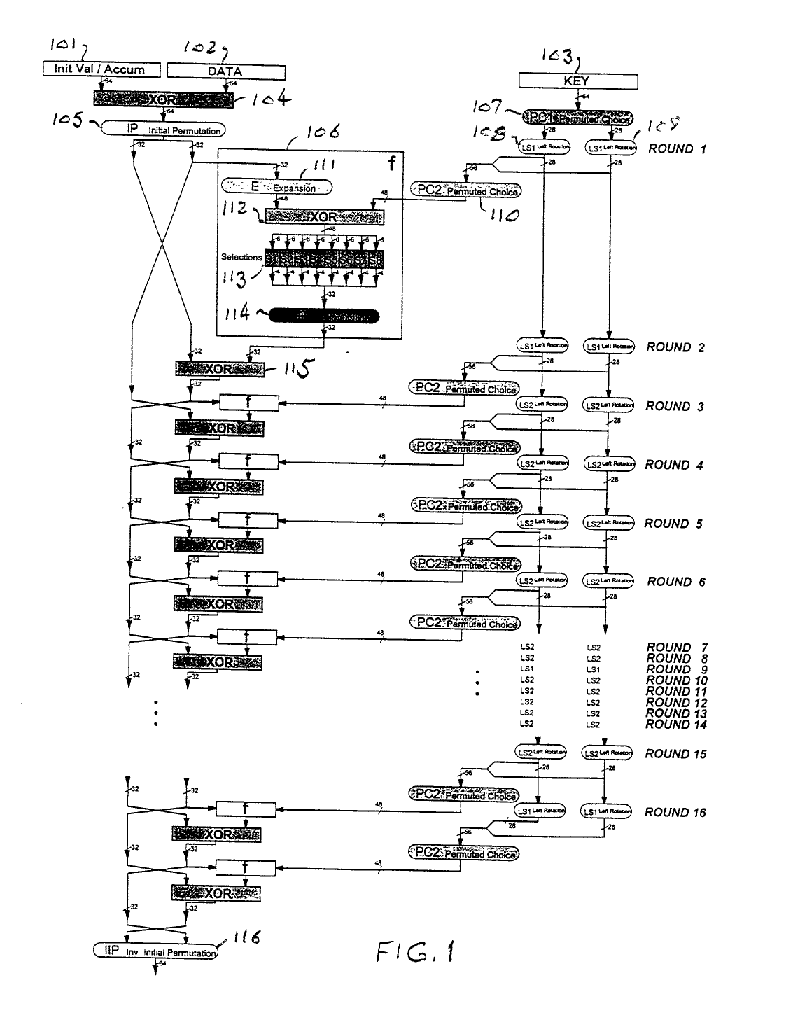

Referring now to the drawings, and more particularly to FIG. 1, there is shown the logic diagram for the hardware implementation of the DES algorithm. The inputs are 64 bits from an initial value accumulator 101, 64 bits from a data register 102, and 64 bits from a key register 103. The 64 bits from each of the initial value accumulator 101 and the data register 102 are exclusive ORed in eXclusive OR (XOR) function 104 and then subjected to an initial permutation, IP, in permutation logic 105. The convention adopted here is that all rounded boxes represent wiring only; that is, the logic functions performed in these blocks involves no active elements. The outputs of permutation logic 105 are two 32-bit blocks, one of which is input to logic function, f, called the cipher function, in logic block 106. This logic block performs a key-dependent computation which involves a function, KS, called the key schedule.

The output of the key register 103 is subjected to a permuted choice, PC1, in permutation logic 107, which outputs two 28-bit blocks. These 28-bit blocks are subjected to left rotations in left rotation logic, LS1, in logic blocks 108 and 109 and combined into a 56-bit block that is further subjected to a further permuted choice, PC2, in permutation logic 110, the output of which is a 48-bit block which is input to logic block 106. Again, each of the logic blocks 107, 108, 109 and 110 are wiring only.

The cipher function, f, logic block 106 subjects the 32-bit block from permutation logic 105 to an expansion in expansion logic 111 to produce a 48-bit block which is combined together with the 48-bit block from permutation logic 110 in exclusive OR function 112. The 48-bit block from the exclusive OR function is divided into eight 6-bit blocks, each of which is subjected to a stage of selection logic 113, also a hardwired function. Each stage of the selection logic 113 outputs a 4-bit block which, when combined with the 4-bit blocks of the other seven stages, produces a 32-bit block. This 32-bit block is then subjected to a further permutation in permutation logic 114, which outputs a 32-bit block. This completes round 1 of the iterative computation of the DES encryption function.

The 32-bit block from logic block 106 and the other 32-bit block from initial permutation logic 105 are input to exclusive OR function 115 to begin round 2 of the DES encryption function. The logic of each round is the same as the logic of the round 1 just described, and there are sixteen rounds culminating in a final inverse initial permutation, IIP, in permutation logic 116 which outputs the 16-bit enciphered block.

According to the DES algorithm, the 64 bits of the input block in register 102 after being exclusive ORed in XOR function 104 with the 64 bits of the initial value accumulator 101 are first subjected to the initial permutation in which the permuted input has bit 58 of the input as its first bit, bit 50 as its second bit, and so on with bit 7 as its last bit. The permuted input block is then the input to a complex key-dependent computation, the output of that computation, called the pre-output, is then subjected to a permutation in permutation logic 116 which is the inverse of the initial permutation in which has bit 40 of the pre-output block as its first bit, bit 8 as its second bit, and so one, until bit 25 of the pre-output block is the last bit of the output.

The computation which uses the permuted input block as its input to produce the pre-output block consists, but for a final interchange of blocks, of sixteen iterations of a calculation based on the cipher function, f, which operates on two blocks, one of 32 bits and one of 48 bits, to produce a block of 32 bits. The 64 bits output from initial permutation logic 105 are divided into two blocks of 32 bits which are denoted as blocks L and R, so that the input block is LR. The block of 48 bits from permutation logic 110 is denoted as K which is chosen from the 64-bit key in register 103. An output L′R′ of an iteration with input LR is defined by:

L′=R

R′=L⊕f(R,K)

where f is the enciphering function as described above and ⊕ is the XOR function which is a bit-by-bit addition in modulo 2. If L′R′ is the output of round 16, then R′L′ is the pre-output block. at each round, or iteration, a different block K of key bits is chosen from the 64-bit key designated by KEY. KS is a function which takes an integer n in the range of one to sixteen and a 64-block KEY as input and yields as output a 48-bit block Kₙ from permutation logic 110 in round 1 and similar logic in each of the following rounds, which is a permuted selection of bits from KEY. That is

Kₙ=KS(n,KEY)

with Kₙ determined by the bits in 48 distinct bit positions of KEY. KS is called the key schedule because the block K used in the n-th iteration is the block Kₙ. The key schedule KS is described in detail in the Appendix to FIPS PUB 46-3, mentioned above.

As mentioned, the permutation applied by permutation logic 116 to the pre-output block is the inverse of the initial permutation in permutation logic 105. If follows that

R=L′

L=R′⊕f(L′,K)

As a result, to decipher the encrypted data, it is only necessary to apply the same algorithm to the enciphered message block, taking care that at each iteration of the computation, the same block of key bits, K, is used during deciphering as was used during enciphering. This can be expressed as

Rₙ₋₁=Lₙ

Lₙ₋₁=Rₙ⊕f(Lₙ,Kₙ)

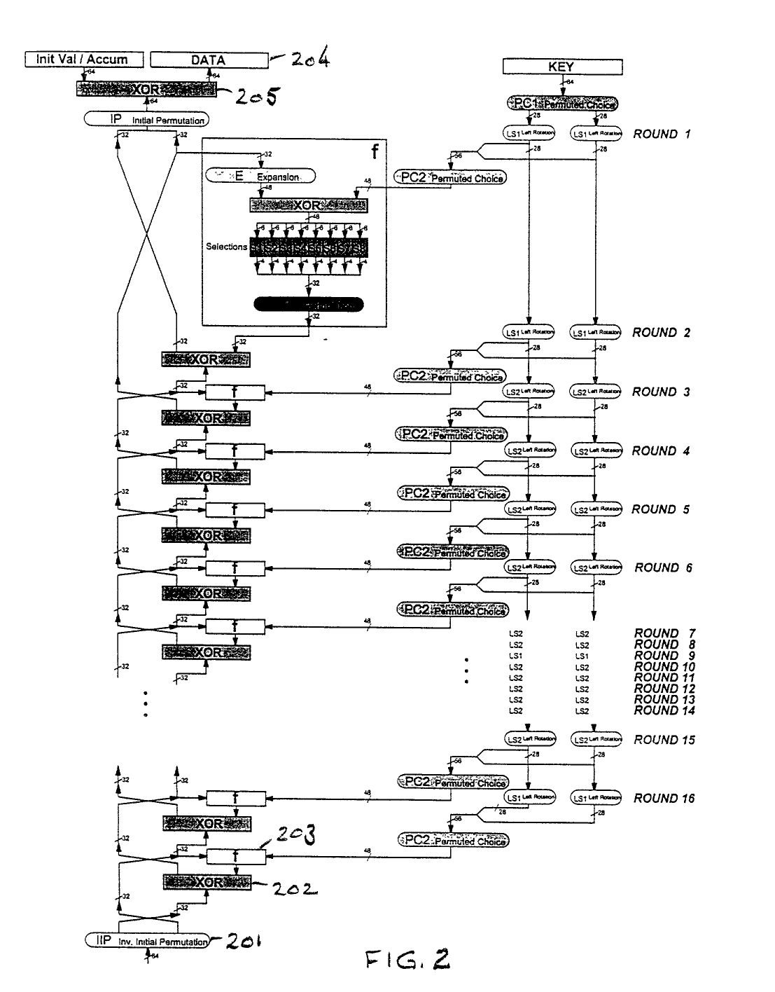

FIG. 2 shows the logic which implements the DES decryption algorithm in hardware. This logic is the inverse of that shown in FIG. 1 with the encrypted data being subjected to an inverse initial permutation in permutation logic 201. 32 bits of the permuted output of the permutation logic 201 are input to one input of exclusive OR function 202, the other input of which is supplied by enciphering logic function, f, 203. The computation process proceeds through sixteen rounds as in the encryption logic shown in FIG. 1, with the final output being 64 bits loaded into data register 204 from exclusive OR function 205.

The invention is not limited to the DES algorithm. The teachings of the invention can be applied to other cryptographic algorithms. One example is the CHAIN symmetric-key block cipher described in the paper by Mohammad Peyravian and Don Coopersmith, cited above. For encryption or decryption, CHAIN uses an invertible key-dependent round function which is iterated R times. The round function is defined in terms of three states: mixing, permutation and key-dependent substitution. The round function uses only three basic operations (XOR, table lookup, and substitution) and four 8-bit bijective s-boxes, the latter being lookup tables that map an 8-bit input to an 8-bit output in a non-linear way. This table lookup operation is the only nonlinear step in the algorithm. Using the teachings of this invention for the specific example of the DES algorithm, those skilled in the art will readily understand how to implement the CHAIN algorithm in combinational logic. Implementations of other cryptographic algorithms will be readily apparent from these examples.

While the invention has been described in terms of a preferred embodiment, those skilled in the art will recognize that the invention can be practiced with modification within the spirit and scope of the appended claims.

Having thus described our invention, what we claim as new and desire to secure by letters patent is as follows:

1. A hardware implementation of a crypto-function comprising:
a first register storing data to be encrypted or decrypted;
a second register for receiving data which has been encrypted or decrypted; and
combinational logic performing computation iterations of the crypto-function on data stored in the first register and outputting data to said second register in a single hardware cycle.

2. The hardware implementation of a crypto-function recited in claim 1, wherein the crypto-function is a block cipher algorithm.

3. The hardware implementation of a crypto-function recited in claim 2, wherein the crypto-function is the Data Encryption Standard (DES) algorithm.

4. The hardware implementation of a crypto-function recited in claim 2, wherein the crypto-function is the CHAIN algorithm.

5. The hardware implementation of a crypto-function recited in claim 2, wherein the combinational logic performs an invertible key-dependent round function iterated a predetermined number of times.

6. The hardware implementation of a crypto-function recited in claim 5, wherein the combination logic performs mixing, permutation and key-dependent substitution in each round.

7. The hardware implementation of a crypto-function recited in claim 5, wherein the combinational logic enciphers a block by performing an initial permutation of a block to be enciphered and then a complex key-dependent computation followed by a permutation which is an inverse of the initial permutation.

8. The hardware implementation of a crypto-function recited in claim 7, wherein the combinational logic deciphers a block by performing deciphering using the same key as used to encipher the block in a process that is an inverse of the enciphering process.
